(19) United States
(12) Patent Application Publication
(10) Pub. No.: US 2005/0121899 A1
(43) Pub. Date: Jun. 9, 2005

(54) Decorative label wrap for enhancing the appearance of products in their intended environment of use

(75) Inventors: Wayne A. Detjen, Algoma, WI (US); Todd A. Ostendorf, Green Bay, WI (US)

Correspondence Address: Stephen B. Salai, Esq.;Harter, Secrest & Emery LLP, 1600 Bausch & Lomb Place, Rochester, NY, 14604-2711, US

(73) Assignee: W S Packaging Group, Inc., Algoma, WI (US)

(21) Appl. No.: 10/728,606

(22) Filed: Dec. 5, 2003

(51) Int. Cl. B42D 15/00

(52) U.S. Cl. 283/81

(57) ABSTRACT

A decorative wraparound label is provided with multiple display modes. The label is divided into a permanently adhered portion and a releasable portion. At least part of the releasable portion includes information associated with conventional product labels including product brand identification and contents information. At least part of the permanently adhered portion includes a decoration pattern intended for enhancing the appearance of the product. For further improving the appearance of a product within its intended environment of use, the information section is detachable for revealing an underlying portion of the decorative pattern. Preferably, the decorative pattern surrounds the entire periphery of the product when the information section is removed. Additional product information can still be accessed even after the primary label ahs been removed by including an information section within the permanently adhered portion of the label and including a decoration section within the releasable portion of the label. One part of the decoration section can be temporarily retracted to allow viewing of the additional information and can be restored to its original overlapping position for restoring the enhanced appearance of the product.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO A “SEQUENCE LISTING”

Not applicable.

### BACKGROUND OF THE INVENTION

1. Field of the Invention

The invention related generally to the field of product labeling and to product labels that are visible at the point of sale, as well as in the environment of the intended use of the products.

2. Description of Related Art

Product labels provide information about the products to which they are affixed. Much of this information is required or important for identifying the product, its contents, and conditions or directions for use. However, once such labeled products are put into use, such as in a home or business environment, the product labeling can detract from the appearance of the product. Product designers often pay particular attention to the appearance of their products or the containers in which they are housed. Careful attention to the details of shape and color of the products or product containers is often made. However, the labeling requirements at the point of sale are not necessarily of those at the point of use, and the information important to display at the point of sale, may actually render the product or the products container unsightly at the time of use.

### BRIEF SUMMARY OF THE INVENTION

Our invention features a multi-purpose wrapping label that is adaptable to different environments of use. For example, the new wrapping label can be made convertible between a first display mode for presenting information about a product and a second display mode for presenting a decorative motif appropriate for the products environment of use. Our preferred multi-purpose label includes both product information and a decorative pattern and is convertible between display modes that feature one or the other. In accordance with the invention, product appearance in the environment of the product's use while still providing all of the information necessary for identifying or describing the product at its point of sale or distribution. The invention also provides for accessing product information within the intended environment of use without sacrificing the desired appearance of the product.

One preferred example of our new decorative wrapping label is arranged for wrapping the periphery of a product and has a first appearance for identifying the product to a consumer and a second appearance for matching the product to its intended environment of use. The new wrapping label takes the form of an elongated label having an adhesive back surface and a printed front surface divided between a permanently adhered section and a releasable section. A release coating is applied in the printed front surface of the permanently adhered section. In addition, the printed front surface of the permanently adhered section is printed with a decorative pattern along a length of the elongated label extending around the periphery of the product. The printed front surface of the releasable section is printed with product identifying information along the length of the elongated label in a position overlapping a portion of the permanently adhered section that is printed with a decorative pattern. A line of weakness separates the permanently adhered section and the releasable section. The releasable section is detachable from the elongated label along the line of weakness for revealing more of the decorative pattern around the periphery of the product.

The decorative pattern is preferably a graphic pattern devoid of text arranged for compatibility with its environment of use. For example, decorative floral patterns are preferred for many home environments. Neutral geometric patterns are preferred for many commercial product applications. The permanently adhered section preferably extends in length around the entire periphery of the product. The decorative pattern also preferably covers the entire periphery of the product. The releasable section is preferably detachable so that the decorative pattern is visible around the entire periphery of the product.

Although product information is of primary importance at the point of sale or distribution, information about the product may be needed for reference or other purposes during the period of product use. The invention also provides in one or more embodiments for accessing product information without sacrificing the desired appearance of the product in its environment of use. For example, the invention provides for dividing the permanently adhered section into a first permanently adhered section printed with additional product information and a second permanently adhered section printed with a decorative pattern. The releasable section is also divided into a first releasable section that is printed with the decorative pattern and a second releasable section that is printed with the product identifying information. The line of weakness separates the first and second releasable sections. Preferably, the first releasable section is sized for overlapping the first permanently adhere section and is temporarily affixed to the permanently adhered section sot that the first releasable section is retractable for revealing the additional product information. In addition, the first releasable section can be reaffixed to the permanently adhered section for recovering the additional product information with the decorative pattern. The first releasable section can be located between the second permanently adhered section and the second releasable section along the length of the elongated label. Thus, the additional product information can be permanently affixed to the product under the cover of a decorative pattern that can be drawn back to view the additional product information and returned for recovering the additional product information with the decorative pattern.

The invention also features a method of labeling a product with a wrapping label that has a first display mode presenting information about the product and a second display mode presenting a decorative motif appropriate for the product's environment of use. An elongated label is wrapped around not only the entire periphery of the product, but also a portion of itself. A permanent bond is formed between the elongated label and the product while a temporary bond is formed between the elongated label and the overwrapped portion of the elongated label. The permanently adhered portion of the elongated label is printed with a decorative pattern extending around the periphery of the product. The temporarily adhered portion of the elongated label is printed with information about the product. The printed information is positioned on the temporarily adhered portion overlying a part of the decorative pattern on the permanently adhered portion in accordance with the first display mode in which the printed information about the product is displayed. A line of weakening is located between the temporarily adhered portion and the permanently adhered portion so that the temporarily adhered portion can be removed form the permanently adhered portion in accordance with the second display mode in which the printed information about the product is removed for revealing the underlying decorative pattern.

The decorative pattern is preferably visible around a limited portion of the product periphery in the first display mode, but the decorative pattern is preferably visible around the entire periphery of the product in the second display mode. The temporarily adhered portion is preferably divided into a first decorative section printed with the decorative pattern and a second information section printed with the product information. The permanently adhered section is preferably divided into a first information section printed with other product information and a second decorative section printed with the same decorative pattern. The first decorative section of the temporarily adhered portion preferably overlies the first information section of the permanently adhered portion. The second information section of the temporarily adhered portion preferably overlies the second decorative portion of the permanently adhered portion. The line of weakening is located between the first decorative section of the temporarily adhered portion and the second information section of the temporarily adhered portion. Opposite ends of the first decorative section of the temporarily adhered portion are located adjacent to the opposite ends of the second decorative section of the permanently adhered portion so that upon removal of the second information section, along the line of weakening, the decorative pattern surrounds the entire periphery of the product.

### BRIEF DESCRIPTION OF THE SEVERAL VIEWS OF THE DRAWING(S)

FIG. 1 is a plan view of a preferred embodiment of my invention showing a wrap around label divided into four distinct sections.

FIG. 2 is a cross-sectional side view of the wraparound label showing a layered construction with exaggerated thickness to aid in the viewing of the layers.

FIG. 3 is a perspective view showing the wraparound label partially wrapped around the periphery of a product.

FIG. 4 is an end view of the product and wraparound label of FIG. 3.

### DETAILED DESCRIPTION OF THE INVENTION

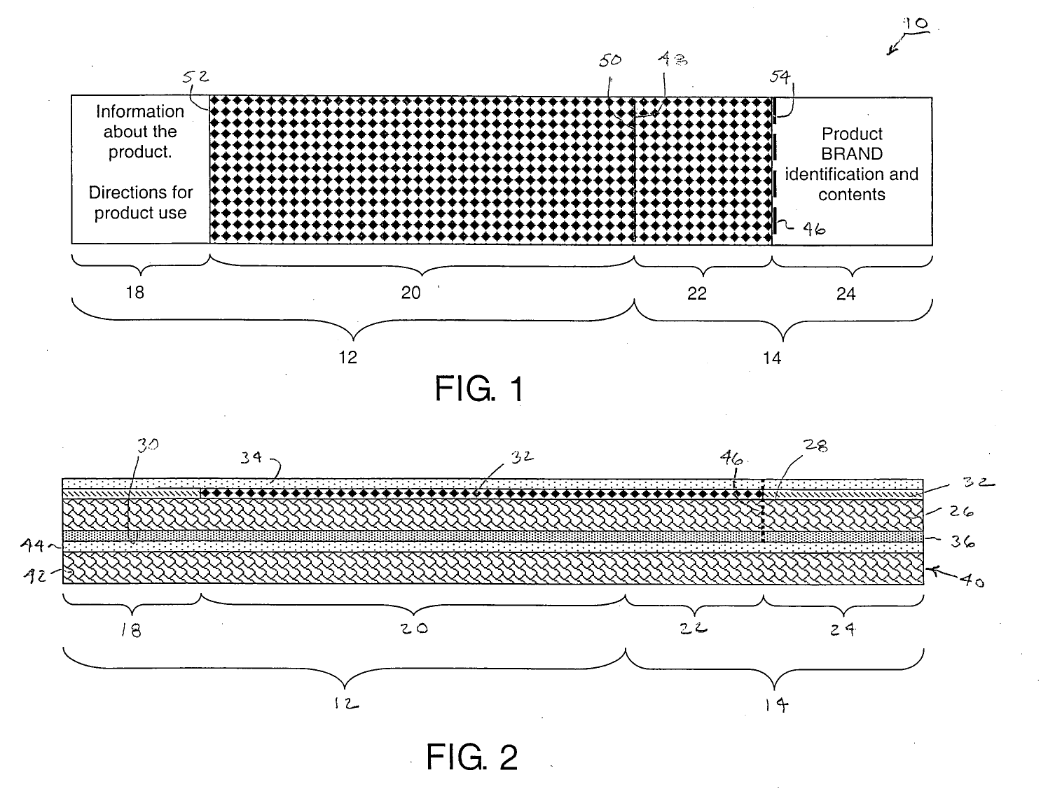

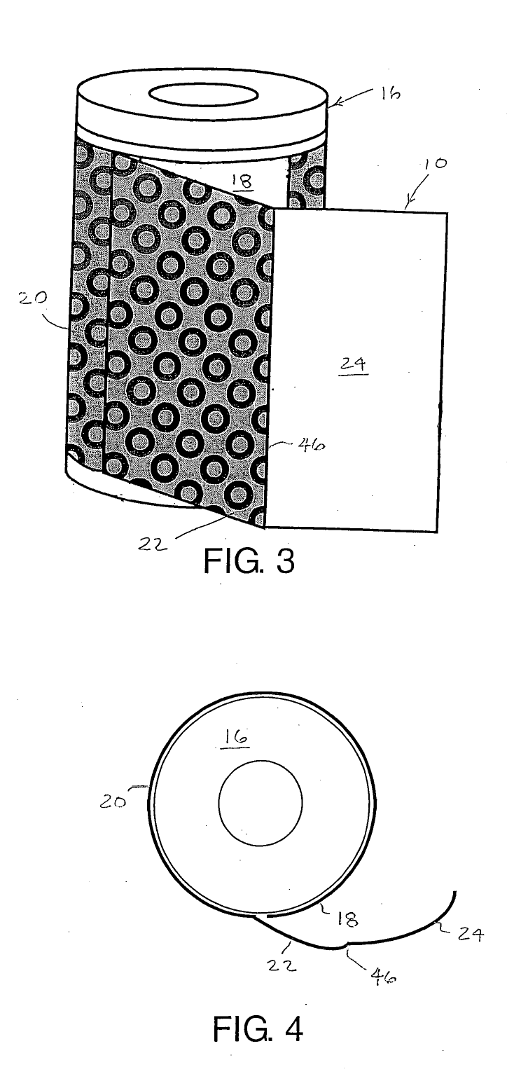

An example of a wraparound label 10 constructed and used in accordance with my invention is shown in the four drawings figures, FIGS. 1-4. The wrapping label is divided along its length into two main sections, a permanently adhered section 12 and a releasable section 14. The permanently adhered section is matched in length to the periphery or circumference of a product 16. The releasable section 14 extends the length of the wraparound label to overlap the permanently adhered section. The permanently adhered section is divided into a first information section 18 and a decoration section 20 and the releasable section 14 is divided into a first decoration section 22 and a second information section 24.

The wraparound label is assembled on a substrate 26, which can be made of paper, plastic, or other known face stock materials for us in forming printed product labels. A front surface 28 of the substrate 26 is adapted for printing. Conventional letter press, digital, thermal imaging can be applied to the surface 28 to produce a printed layer 32. A release coat layer 34 is applied overtop of the printed layer 32. To the back surface 30 of the substrate 26, a pressure sensitive adhesive layer 36 is applied for permanently affixing the wraparound label to the product 16. The same or different printing techniques can be used for printing each of the four sections. The release coat layer 34 is preferably matched to the adhesive layer 36 so that the adhesive layer forms a releasable bond between the overlapping portions of the overwrapping label 10. For example, the release coat layer can be formed from a conventional silicone and the adhesive can be formed of a conventional pressure sensitive adhesive. Although the release coat 34 is only needed in the region overlapped by the releasable section 14 of the wrapping label 10, the entire front surface 28 of the wrapping label is preferably covered with the release coating for ease of manufacture. In addition, the release coating provides a protective covering and maintains a similar appearance between the second decoration section portion of the permanently adhered section and the first decoration section 22 of the releasable section 14. The overwrapping label is preferably mounted on a release liner 40 composed of a base substrate 42 and another release coating layer 44 to protect the adhesive layer 36 until the overwrapping label is affixed to the product 16. For a preferred in-line processing, the overwrapping label 10 can be one of a succession of labels temporarily supported in the release liner 40. However, the continuous release coating layer 34 also permits a succession of the labels to be self-wound without the release liner 40.

For labeling products such as the cylindrical shaped product 16, the permanently adhered portion 12 is wrapped around the entire periphery of the product. The releasable portion 14 overlaps a portion of the permanently adhered portion 12. The first decoration section 22 of the releasable portion 14 is positioned along the length of the label for overlapping the first information section of the permanently adhered portion of the label. The second information section of the releasable portion 14 overlaps a part of the decoration section 20 of the permanently adhered portion of the label. The second information section of the releasable portion of the label is preferably printed with product brand identification and contents information typical of the information which is ordinarily printed on product labels. This information is particularly important for display at the point of sale or distribution of the product 16. However, in accordance with the invention, the second information section 24 is made detachable from the remaining label along a line of weakness such as a line of perforation or a permanent crease. The line of perforation 46 separates the second information section from the first decoration section of the releasable portion of the label. The detachment of the second information section 24, which is the main product label, exposes the previously overlapped part of the second decoration section of the permanently adhered portion of the label. Preferably, the two decoration section 20 and 22 are contiguous for forming an uninterrupted pattern around the periphery of the product and a remote end 48 of the second decoration section of the permanently adhered portion is position adjacent to the remote end 50 of the first decoration section of the releasable portion when mounted on the product 16 so that the two decoration section 20 and 22 cover the entire periphery (360° circumference) of the product 16.

Although the entire periphery is encompassed by the uninterrupted decoration pattern, additional information about the product is still available for viewing beneath the first decoration section 22 of the releasable portion 14. That is, the decoration section 122 can be peeled away from the product to reveal the information printed on the first information section of the permanently adhered potion of the label. The remainder of the decoration pattern formed in the second decoration section of the permanently adhered portion remains affixed to the product 16. After viewing the additional information which can include information about the product or directions for its use, the first decoration section of the releasable portion can be restored to its original position overlapping the first information section of the permanently adhered portion replacing the first decoration section 22 restores the product 16 to its desired appearance in the environment of its intended use.

My new decorative wrapping label 10 is convertible between a first display mode in which the product information on the information section of the releasable portion of the label is visible and a second display mode where the same product information is not visible and is replaced by a continuation of a decorative pattern around the periphery of the product. The invention also features a third display mode in which the decorative pattern can be temporarily retracted to reveal additional product information located beneath the decorative portion of the decorative pattern. The first display mode is intended for the sale or distribution of the product and the second and third display modes are appropriate for supporting the product's use.

The decorative pattern is preferably a graphic pattern devoid of text presenting a decorative motif appropriate for the product's intended environment of use. Floral patterns, stripes, and other repeating geometric shapes are among the patterns contemplated. The design can also be of a type that is completed by the detachment of the second information section and accompanying exposure of the remaining part of the decoration pattern. Themes of use can also be featured such as infant themes, the product shape can be coordinated with the wraparound label to further exploit the invention for improving product appearance. For example, a product could be fashioned on the form of a vase or other decorative vessel, and the decorative pattern could be designed to have the appearance of a stencil on the vessel. A wide variety of other applications will be apparent to those of skill in the art for further exploiting the teachings of this invention.

1. A decorative wrapping label arranged for wrapping the periphery of a product and having a first appearance for identifying the product to a consumer and a second appearance for matching the product to its intended environment of use, comprising:
an elongated substrate having an adhesive back surface and a printed front surface divided between a permanently adhered section and a releasable section;
a release coating on the printed front surface of the permanently adhered section;
the printed front surface of the permanently adhered section being printed with a decorative pattern along a length of the elongated substrate extending around the periphery of the product;
the printed front surface of the releasable section being printed with product identifying information along the length of the elongated substrate in a position overlapping a portion of the permanently adhered section that is printed with the decorative pattern; and
a line of weakness between the permanently adhered section and the releasable section so that in cooperation with the release coating on the printed front surface of the permanently adhered section, the releasable section is detachable from the elongated substrate along the line of weakness revealing more of the decorative pattern around the periphery of the product.

2. The wrapping label of claim 1 in which the permanently adhered section is divided into a first permanently adhered section printed with additional product information and a second permanently adhered section printed with the decorative pattern.

3. The wrapping label of claim 2 in which the releasable section is divided into a first releasable section that is printed with the decorative pattern and a second releasable section that is printed with the product identifying information.

4. The wrapping label of claim 3 in which the line of weakness separates the first and second releasable sections.

5. The wrapping label of claim 4 in which the first releasable section is sized for overlapping the first permanently adhered section and for being temporarily affixed to the first permanently adhered section so that the first releasable section is retractable for revealing the additional product information printed on the first permanently adhered section and so that the first releasable section is reaffixable to the first permanently adhered section for recovering the additional product information printed on the first permanently adhered section.

6. The wrapping label of claim 4 in which the first releasable section is located between the second permanently adhered section and the second releasable section along the length of the elongated substrate.

7. The wrapping label of claim 1 in which the permanently adhered section extends in length around the entire periphery of the product.

8. The wrapping label of claim 7 in which the decorative pattern covers the entire periphery of the product.

9. The wrapping label of claim 8 in which the decorative pattern is a graphic pattern devoid of text.

10. A label wrapping system for a product that is convertible between a first display mode presenting information about the product and a second display mode presenting a decorative motif appropriate for the product's environment of use, comprising:
an elongated substrate having a first portion sized in length for wrapping around the entire periphery of the product and a second portion sized in length for overwrapping a portion of the length of the first portion of the elongated substrate;
the first portion of the elongated substrate having a front surface printed in a decorative pattern and a back surface arranged for permanently bonding the first portion of the elongated substrate to the product;
the second portion of the elongated substrate having a front surface printed with information about the product and a back surface arranged for temporarily bonding the second portion of the elongated substrate to the front surface of the first portion of the elongated substrate; and
at least part of the second portion of the elongated substrate being detachable from the first portion of the elongated substrate for converting the label wrapping system from the first display mode in which the printed information about the product is displayed to the second display mode in which the printed information about the product is removed revealing an overlapped part of the decorative pattern.

11. The label wrapping system of claim 10 in which the first portion of the elongated substrate includes a first information section in which other product information is printed on the front surface of the first portion of the elongated substrate and a second decoration section in which the decorative pattern is printed on a remaining part of the front surface of the first portion of the elongated substrate.

12. The label wrapping system of claim 11 in which the second portion of the elongated substrate includes a first decoration section in which the decorative pattern is printed on the front surface of the second portion of the elongated substrate and a second information section in which the product information is printed on a remaining part of the front surface of the second portion of the elongated substrate.

13. The label wrapping system of claim 12 in which the second information section of the second portion of the elongated substrate is detachable from the first decoration section of the second portion of the elongated substrate.

14. The label wrapping system of claim 13 in which the first decoration section of the second portion of the elongated substrate is retractable for revealing the other product information printed on the first information section of the first portion of the elongated substrate.

15. The label wrapping system of claim 14 in which the first decoration section of the second portion of the elongated substrate is rebondable to the first information section of the first portion of the elongated substrate.

16. The label wrapping system of claim 12 in which the first decoration section of the second portion of the elongated substrate includes an uninterrupted part of the decorative pattern printed on the second decoration section of the first portion of the elongated substrate.

17. The label wrapping system of claim 16 in which one end of the first decoration section of the second portion of the elongated substrate is contiguous with one end of the second decoration section of the first portion of the elongated substrate and another end of the first decoration section of the second portion of the elongated substrate is arranged for being wrapped adjacent to another end of the second decoration section of the first portion of the elongated substrate for displaying the decorative pattern around the entire periphery of the product.

18. The label wrapping system of claim 10 in which a release is applied to the front surface of the first portion of the elongated substrate and an adhesive is applied to the back surface of the second portion of the elongated substrate for forming a temporary bond between the first and second portions of the elongated substrate.

19. The label wrapping system of claim 18 in which a common adhesive is applied to the back surfaces of the first and second portions of the elongated substrate.

20. A multipurpose label comprising:
a substrate sized in length greater than a periphery of a product;
a front surface of the substrate being covered with a release and a back surface of the substrate being covered with an adhesive that is compatible with the release for forming a releasable bond between first and second portions of the substrate;
the front surface of the first portion of the substrate being printed with information about the product and the front surface of the second portion of the substrate being printed with a decoration pattern that is sized in length to extend around the entire periphery of the product; and
the first portion of the substrate overlapping a part of the second portion of the substrate with the releasable bond and being removable for revealing the decorative pattern around the entire periphery of the product.

21. The label of claim 19 in which the decorative pattern is a graphic pattern devoid of text.

22. The label of claim 19 in which the removal of the first portion of the substrate completes the graphic pattern.

23. The label of claim 19 in which the first portion includes both a decoration section printed with the decorative pattern and an information pattern printed with the product information.

24. The label of claim 23 in which the second portion includes both an additional product information section and a decoration section that is printed with the decorative pattern.

25. The label of claim 24 in which the decoration section of the first portion is releasable from the additional product information section for temporarily retracting the decoration section of the first portion and temporarily revealing the additional product information.

26. A method of labeling a product with a wrapping label having a first display mode presenting information about the product and a second display mode presenting a decorative motif appropriate for the product's environment of use, comprising steps of:
wrapping an elongated substrate around a periphery of a product and a portion of the elongated substrate already wrapped around the periphery of the product;
forming a permanent bond between the elongated substrate and the product and a temporary bond between the elongated substrate and the overwrapped portion the elongated substrate;
the permanently adhered portion of the elongated substrate being printed with a decorative pattern extending around the periphery of the product;
the temporarily adhered portion of the elongated substrate being printed with information about the product;
positioning the printed information on the temporarily adhered portion overlying a part of the decorative pattern on the permanently adhered portion in accordance with the first display mode in which the printed information about the product is displayed; and
locating a line of weakening between the temporarily adhered portion and the permanently adhered portion so that the temporarily adhered portion can be removed from the permanently adhered portion in accordance with the second display mode in which the printed information about the product is removed revealing the underlying decorative pattern.

27. The method of claim 26 in which the decorative pattern is visible around a limited portion of the product periphery in the first display mode, and the decorative pattern is visible around the entire product periphery in the second display mode.

28. The method of claim 27 in which the temporarily adhered portion is divided into a first decoration section printed with the decorative pattern and a second information section printed with the product information.

29. The method of claim 28 in which the permanently adhered portion is divided into a first information section printed with other product information and a second decoration section printed with the decorative pattern.

30. The method of claim 29 in which the step of positioning includes positioning the first decoration section of the temporarily adhered portion over the first information section of the permanently adhered portion.

31. The method of claim 30 in which the step of positioning includes positioning the second information section of the temporarily adhered portion over the second decoration section of the permanently adhered portion.

32. The method of claim 31 in which the step of locating includes locating the line of weakening between the first decoration section of the temporarily adhered portion and the second information section of the temporarily adhered portion.

33. The method of claim 29 including a step of aligning opposite ends of the first decoration section of the temporarily adhered portion adjacent to opposite ends of the second decoration section of the permanently adhered portion so that upon removal of the second information section along the line of weakening, the decorative pattern surrounds the entire periphery of the product.
